(19) United States
(12) Patent Application Publication
(10) Pub. No.: US 2007/0186738 A1
(43) Pub. Date: Aug. 16, 2007

(54) Tibial cut guide assembly having rotatable cut guide body

(75) Inventors: Shawn E. McGinley, Fort Wayne, IN (US); Michael D. Schwartz, Fort Wayne, IN (US)

Correspondence Address: ZIMMER TECHNOLOGY - BAKER & DANIELS, 111 EAST WAYNE STREET, SUITE 800, FORT WAYNE, IN, 46802, US

(73) Assignee: Zimmer Technology, Inc.

(21) Appl. No.: 11/343,849

(22) Filed: Jan. 31, 2006

(51) Int. Cl. B26D 7/06

(52) U.S. Cl. 83/88

(57) ABSTRACT

A guide assembly including a riser and a guide body. Riser has first and second ends. First end has a first opening defining a first axis. First opening is defined by a wall and includes a shoulder extending about wall. First opening also has a channel defined in wall. Channel extends parallel to first axis. Cut guide body has a first bone engaging surface, an opposing second surface and opposing proximal and distal sides. Cut guide includes a post extending vertically from distal side and defining a post axis. Post is rotatably received within first opening of riser. Cut guide includes a boss extending from post at an angle to post axis. Boss is slidable within channel to enable post to be inserted into first opening. Post is rotatable about post axis and boss engages shoulder to prevent vertical movement of post in first opening.

### BACKGROUND

The present invention relates to cut guides for use in arthroplastic surgery and, more particularly, cut guides for use in guiding the cutting of the proximal end of the tibia.

Orthopedic procedures for the replacement of all, or a portion of, a patient's joint typically require resecting (cutting) and reshaping of the ends of the bones of the joint. For instance, total knee replacement procedures typically involve resecting the distal end of the femur and the proximal end of the tibia prior to implanting the prosthesis components. Resecting the distal end of the femur often involves making several cuts of the distal end of the femur including a distal cut. Resecting the proximal end of the femur often involves making a proximal cut.

Cut guides have been developed to guide the saw and achieve the proper angle and position of these cuts. Conventional cut guides are often in the form of blocks having slots therein for receiving and guiding the saw. In use, the block is positioned against the bone with the help of positioning and alignment equipment. The block is then secured to the bone using fasteners. Although effective in guiding the cutting of the tibia, it may be challenging to advance the block through the surrounding tissues and under the patella, and to properly position the block on the tibia. This is particularly the case in minimally invasive procedures in which minimal disruption to surrounding tissues is desired and everting of the tibia is avoided.

Accordingly, there is a need for cut guides that can be more effectively positioned and used in minimally invasive techniques.

### SUMMARY

The present invention provides cut guides for use in guiding the cutting of the proximal end of the tibia. In one form, the invention provides a tibial cut guide assembly for resecting a proximal end of a tibia. The tibia includes the proximal end, an opposing distal end and a tibial axis extending from the proximal end to the distal end. The cut guide assembly includes a guide riser and a cut guide body rotatably mountable to the guide riser. The guide riser has a first end and an opposite second end. The first end has a first opening extending therethrough and defining a first axis. The first opening is defined by a wall and includes a shoulder extending about the wall. The first opening also has a channel defined in the wall. The channel extends parallel to the first axis and through the shoulder. The cut guide body has a first bone engaging surface, an opposing second surface and opposing proximal and distal sides extending between the first and second surfaces. The cut guide has at least one cut guide surface extending between the first and second surfaces. The cut guide includes a mounting post extending vertically from the distal side and defining a post axis. The mounting post is configured to be rotatably received within the first opening of the riser. The cut guide includes a boss extending from the mounting post at an angle to the post axis. The boss is slidable within the channel to enable the mounting post to be inserted into the first opening. When the mounting post is disposed in the first opening, the mounting post is rotatable about the post axis and the boss engages the shoulder to prevent vertical movement of the mounting post in the first opening.

In another form, the invention provides a tibial cut guide assembly including a tibial alignment member, a cross member, a guide riser and a cut guide body. The tibial alignment member defines an alignment axis and is adapted to be mounted to the tibia with the alignment axis being parallel to the tibial axis. The cross member is elongate and is slidingly mounted to the alignment member. The cross member is slidable relative to the alignment member along the alignment axis. The cross member defines a cross member axis being substantially perpendicular to the alignment axis. The guide riser has a first end and a second end. The first end defines a first opening extending therethrough along a first axis. The second end defines a second opening extending therethrough along a second axis. The second axis is substantially perpendicular to the first axis. The cross member is slidingly received within the second opening. The first opening is defined by a wall extending about a diameter. The wall has a shoulder extending about the diameter. The first opening has a channel defined in the wall. The channel extends parallel to the first axis and through the shoulder. The cut guide body has a first bone engaging surface, an opposing second surface and opposing proximal and distal sides extending between first and second surfaces. The cut guide has at least one cut guide surface extending between the first and second surfaces. The cut guide has a mounting post extending vertically from the distal side and defining a post axis. The mounting post is configured to be rotatably received within the first opening of the riser. The cut guide includes a boss extending from the mounting post at an angle to the post axis. The boss is slidable within the channel to enable the mounting post to be inserted into the first opening. When the mounting post is disposed in the first opening, the mounting post is rotatable about the first axis and the boss engages the shoulder to prevent vertical movement of the mounting post in the first opening.

In yet another form, the present invention provides a tibial cut guide assembly including a guide riser and a cut guide body rotatably coupled to the guide riser. The guide riser has a first end and an opposite second end. The first end has a first opening extending therethrough and defining a first axis. The first opening is defined by a wall and includes a first diameter and a second diameter. The second diameter is greater than the first to thereby form a shoulder extending about the wall. The cut guide body has a first bone engaging surface, an opposing second surface and opposing proximal and distal sides extending between the first and second surfaces. The cut guide has at least one cut guide surface extending between the first and second surfaces. The cut guide includes a mounting post extending vertically from the distal side and defining a post axis. The mounting post is rotatably received within the first opening of the riser such that the cut guide body is rotatable relative to the riser about the post axis. The cut guide body includes a vertical inhibiting member extending from the mounting post at an angle to the post axis. The vertical inhibiting member engages the shoulder to prevent vertical movement of the mounting post in the first opening.

In still another form, the present invention provides a tibial cut guide assembly including a guide riser and a cut guide body. The guide riser has a first end and an opposite second end. The first end has a first opening extending therethrough. The first opening is defined by a cylindrical wall. The cut guide body has a first bone engaging surface, an opposing second surface and opposing proximal and distal sides extending between the first and second surfaces. The cut guide has at least one cut guide surface extending between the first and second surfaces. The cut guide has a cylindrical mounting post extending vertically from the distal side and defining a post axis. The mounting post is configured to be rotatably received within the first opening of the riser such that the cut guide body is rotatable relative to the riser about the post axis. Either the wall or the mounting post includes both a shoulder extending thereabout and a channel. The channel extends parallel to the post axis. The other of wall and mounting post includes a boss extending therefrom at an angle to the post axis. The boss is slidable within the channel to enable the mounting post to be inserted into the first opening. When the mounting post is disposed in the first opening, the mounting post is rotatable about the first axis and the boss engages the shoulder to prevent vertical movement of the mounting post in the first opening.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of a tibial cut guide assembly according to one embodiment of the present invention;

FIG. 2 is a perspective view of the riser of the assembly of FIG. 1;

FIG. 3 is a top (proximal) view of the riser of FIG. 2;

FIG. 4 is a bottom (distal) view of the riser of FIG. 2;

FIG. 5 is a sectional view of the riser of FIG. 3 taken along lines 5-5;

FIG. 6 is front view of the cut guide body of the assembly of FIG. 1;

FIG. 7 is a back view of the cut guide body of the assembly of FIG. 1;

FIG. 8 is perspective view of the cut guide body of the assembly of FIG. 1;

FIG. 9 is a perspective view of a riser of a cut guide assembly according to another embodiment of the present invention;

FIG. 10 is a bottom (distal) view of the riser of FIG. 9;

FIG. 11 is a sectional view of the riser of FIG. 10 taken along lines 11-11;

FIG. 12 is a perspective view of a cut guide body for use with the riser of FIG. 9;

FIG. 13 is a perspective view of the tibial cut guide assembly of FIG. 1 in position for use in resecting the proximal end of a tibia; and

FIG. 14 is an anterior view of the tibial cut guide assembly of FIG. 13.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The present invention will now be described with reference to the attached figures. The description below may include references to the following terms: anterior (at or near the front of the body, as opposed to the back of the body); posterior (at or near the back of the body, as opposed to the front of the body); lateral (at or near the side of the body, farther from the midsagittal plane, as opposed to medial); medial (at or near the middle of the body, at or near the midsagittal plane, as opposed to lateral); proximal (toward the beginning, at or near the head of the body, as opposed to distal) and distal (further from the beginning, at or near the foot of the body, as opposed to proximal).

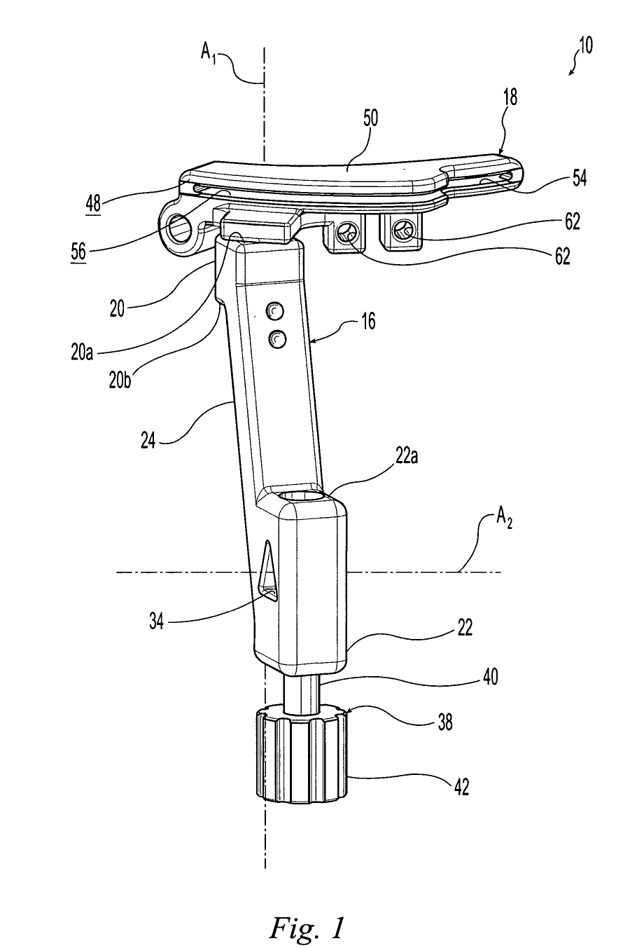

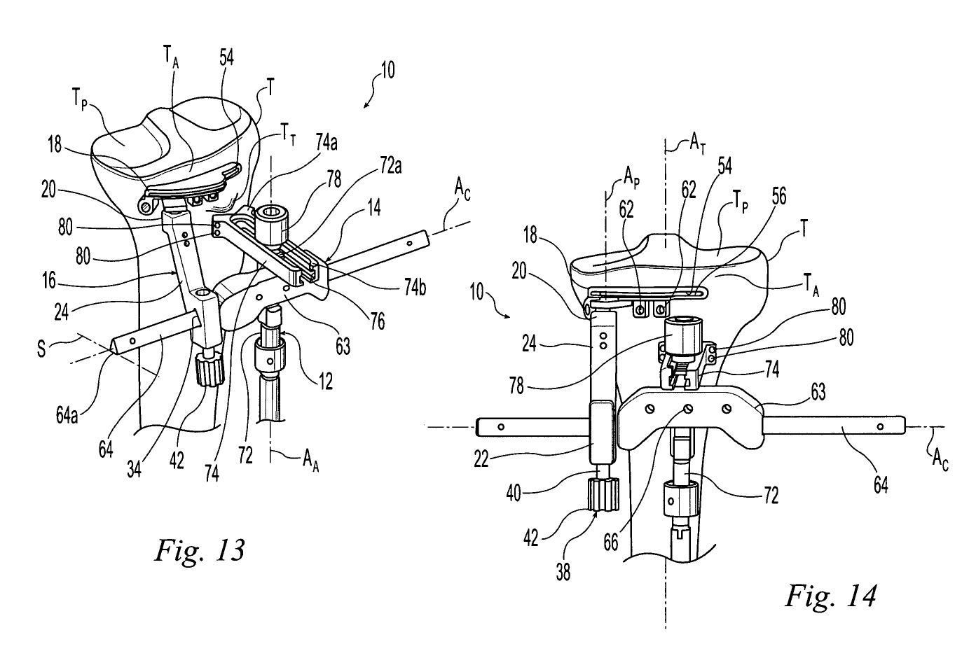

Referring first to FIG. 1, tibial cut guide assembly 10 according to one embodiment of the present invention is illustrated. Tibial cut guide assembly 10 generally includes guide riser 16 and cut guide body 18 pivotally mounted to riser 16. As is discussed in further detail below, tibial cut guide assembly 10 is adapted to cooperate with additional components, such as tibial boom or cross member 14 and alignment member 12 (FIGS. 13 and 14), to resect (cut) the proximal end of a tibia.

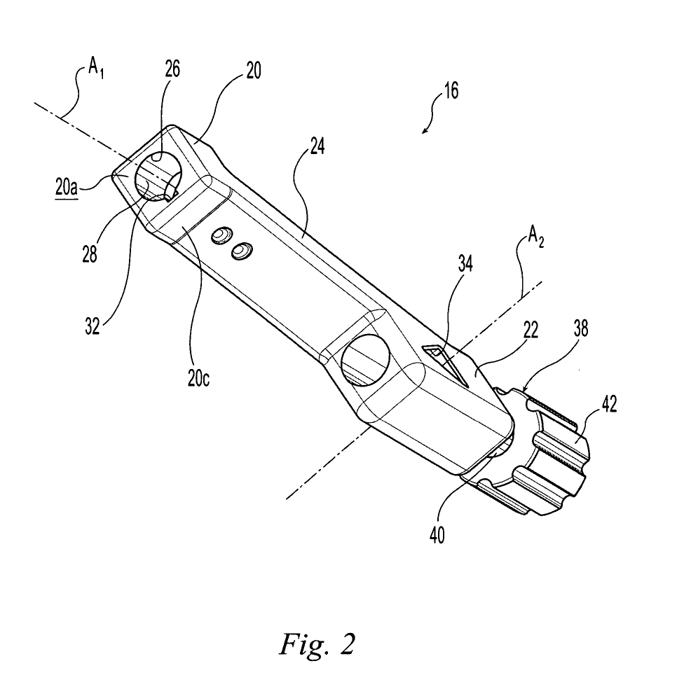

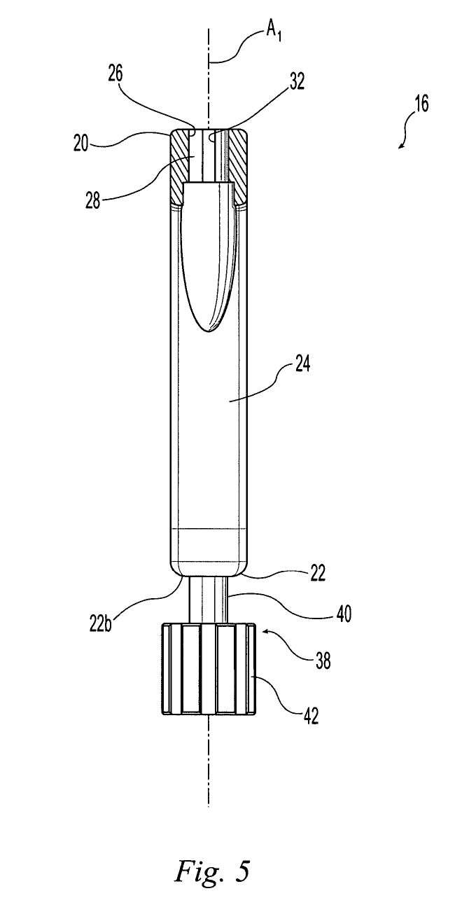

Turning now to FIGS. 1-5, guide riser 16 includes first end 20, opposite second end 22 and angled portion 24 extending between first and second ends 20, 22. Each of first and second ends 20, 22 have a block-like shape and include respective upper surfaces 20a, 22a and respective lower surfaces 20b, 22b. First end 20 of guide riser 16 also includes anterior side 20c and opposite posterior side 20d. Guide riser 16 includes first, vertical opening 26 extending through first end 20 from upper surface 20a to lower surface 20b. First opening 26 defines first axis A₁ and is defined by substantially cylindrical wall 28, which extends about first axis A₁. Referring particularly to FIGS. 4 and 5, first opening 26 has first diameter D₁ and second diameter D₂. Second diameter D₂ is larger than first diameter D₁ such that shoulder or ledge 30 is formed in and extends about wall 28. Turning specifically to FIGS. 2-5, groove or channel 32 is formed in wall 28 at a position proximal to anterior side 30c of first end 20. Channel 32 extends parallel to first axis A₁ and through shoulder 30.

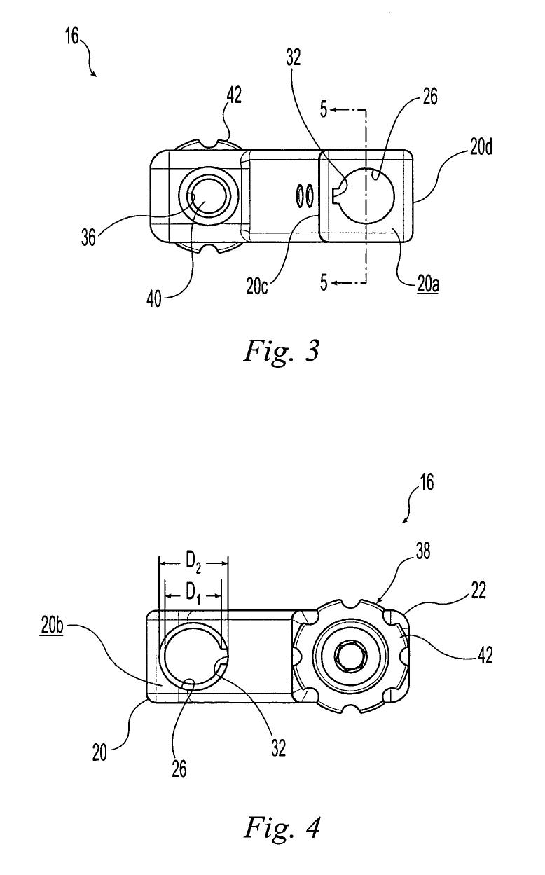

Turning now to FIGS. 1 and 2, guide riser 16 includes second, horizontal opening 34 extending through second end 22 along second axis A₂. Second axis A₂ is substantially perpendicular to first axis A₁. Second opening 34 is triangular in cross-section and, as discussed in further detail below, is configured to slidingly receive a part of tibial boom 14 (FIGS. 13 and 14). As illustrated in FIG. 3, guide riser 16 also includes threaded hole 36, which intersects second opening 34 (FIGS. 1 and 2). As shown in FIGS. 1-5, guide riser 16 further includes locking member 38. Locking member 38 includes threaded shaft 40 and knob 42 coupled to one end of shaft 40. Threaded shaft 40 adjustably engages threaded hole 36 such that knob 42 may be used to rotate shaft 40 further into or out of hole 36. Shaft 40 is configured to intersect second opening 34 when rotated into deep engagement with hole 36.

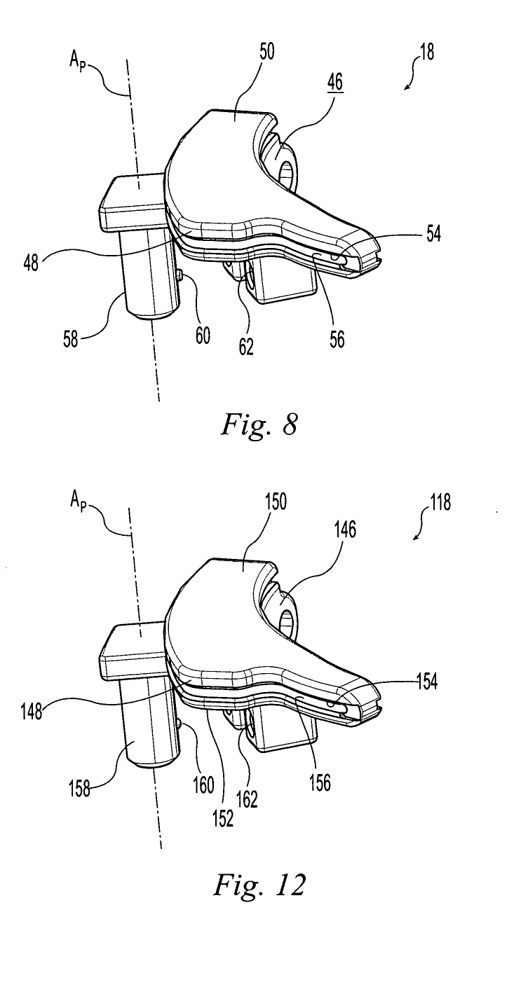

Referring now to FIGS. 1 and 6-8, cut guide body 18 includes first bone engaging surface 46 and opposing second surface 48. Bone engaging surface 46 is contoured to be positioned against the surface of tibia T (FIGS. 13 and 14). Cut guide body 18 also includes proximal side 50 and opposing distal side 52, both extending between first and second surfaces 46, 48. Cut guide slot 54 extends through guide body 18 from first surface 46 to second surface 48 and provides cut guide surface 56. Slot 54 is configured to receive a cutting instrument, such as a saw, and cut guide surface 56 is adapted to guide the cutting instrument in resecting the proximal end of tibia T (FIGS. 13 and 14).

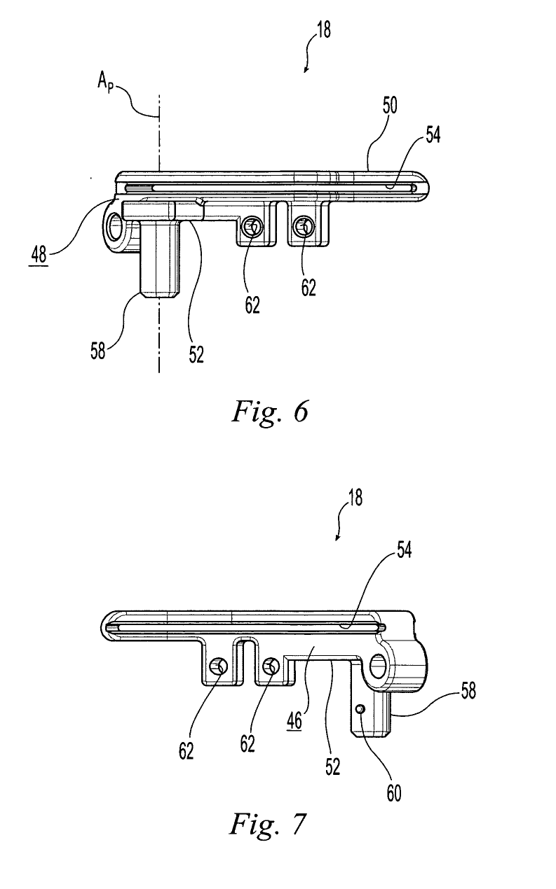

Turning specifically to FIGS. 6-8, mounting post 58 extends vertically from distal side 52. Mounting post 58 is substantially cylindrical in shape and defines post axis A_{P}. Mounting post 58 is configured to be rotatably received in first opening 26 of guide riser 16. Cut guide body 18 also includes vertical inhibiting member or boss 60, which extends perpendicularly from mounting post 58 at a position proximal to and toward first surface 46. Boss 60 is cylindrical in shape and is configured to slide within channel 32. Fastener receiving holes 62 extend through cut guide body 18 from first surface 46 to second surface 48.

Referring now to FIGS. 1-5 and 7-8, the method for assembling tibial cut guide assembly 10 will now be described. Cut guide body 18 is rotatably mounted on first end 20 of guide riser 16 by aligning mounting post 58 and post axis A_{P} with first opening 26 and first axis A₁ such that boss 60 is positioned in alignment with channel 32. In this position, first bone engaging surface 46 of cut guide body 18 and anterior side 20c of first end 20 face in a common direction. Mounting post 58 is then inserted into first opening 26, while boss 60 slides along channel 32 until boss 60 passes shoulder 30 and enters second diameter D₂ region of first opening 26. At this point, mounting post 58 may be rotated within first opening 26 about post axis A_{P} to, thereby, rotate cut guide body 18 relative to guide riser 16 and along a plane parallel with cut guide slot 54. As mounting post 58 is rotated within first opening 26, boss 60 travels about wall 28 along shoulder 30 and engages shoulder 30 to prevent post 58 from moving vertically within first opening 26.

Turning now to FIGS. 13 and 14, operation of cut guide assembly 10 will now be described. As noted above, cut guide assembly 10 is adapted to cooperate with additional components, such as tibial boom or cross member 14 and tibial tubercle alignment member 12, to resect the proximal end of the tibia in a manner similar to that described in U.S. Patent Publication No. 2004/0153066 filed as U.S. application Ser. No. 10/357,282 in the names of Coon et al., entitled Apparatus for Knee Surgery and Method of Use, assigned to the assignee of the present invention, and hereby incorporated by reference; and The Zimmer Institute Surgical Technique, “MIS™ Quad-Sparing™ Surgical Technique for Total Knee Arthroplasty NEXGEN® COMPLETE KNEE SOLUTION”, The Zimmer Institute, 2004 also hereby incorporated by reference.

More specifically, tibial boom or cross member 14 includes body 63 and pair of extension bars 64 extending from either side of body 63 along cross member axis A_{C}. Extension bars 64 are triangular in cross-section and, therefore, are configured to be received in second opening 34 of guide riser 16. Extension bars 64 are provided with distal flat portion 64a, which extends along plane or slope S. Body 63 includes a dove-tail channel (not shown) extending centrally along body 63 perpendicular to cross member axis A_{C}. Locking bolt receiving hole 66 extends through body 63 and intersects dove-tail channel (not shown). Locking bolt receiving hole 66 is configured to receive a locking bolt similar to locking member 38.

Referring still to FIGS. 13 and 14, tibial tubercle alignment member 12 includes tubercle alignment bar 72 having proximal end 72a and opposite distal end (not shown). Alignment bar 72 defines alignment axis A_{A} extending from first end 72a to second end 72b. Alignment member 12 also includes tubercle alignment guide 74 having first tubercle engagement end 74a, opposing second end 74b, elongate slot 76 extending therethrough between first and second ends 74a, 74b and a plurality of fastener receiving holes 80 extending through first end 74a. First end 74a is configured to be positioned against tubercle T_{T} of tibia T. Proximal end 72a of alignment bar 72 is configured to slidingly engage slot 76. Locking bolt 78 extends through slot 76 and is configured to adjustably engage with a hole (not shown) in proximal end 72a of alignment bar 72. Locking bolt 78 is adjustable between a locked position and an unlocked position. In the locked position, locking bolt 78 engages alignment guide 74 to secure proximal end 72a of alignment bar 72 in position in slot 76 and prevent proximal end 72a from sliding in slot 76. In the unlocked position, locking bolt 78 is released from alignment guide 74 to permit proximal end 72a to slide along slot 76.

Alignment bar 72 includes a dove-tail portion (not shown), which is configured to be slidingly received in the dove-tail channel (not shown) of body 63 to slidingly couple cross member 14 to alignment member 12. When cross member 14 is slidingly coupled to alignment member 12, cross member axis A_{C} extends perpendicularly to alignment member axis A_{A} and body 18 (along with extension bars 64) is slidable relative to alignment bar 72 along alignment member axis A_{A}. In addition, when cross member 14 is slidingly coupled to alignment bar 12, slope S of proximal flat portion 64a extends at a non-perpendicular angle to alignment axis A_{A}. More particularly, slope S extends relative to alignment axis A_{A} at an angle accommodating the desired posterior slope angle, as discussed in further detail below and in U.S. Patent Publication No. 2004/0153066 incorporated by reference above.

In use, cross member 14 is slidably coupled to alignment member 12 as described above. The proximal end (not shown) of alignment bar 72 may be coupled to a known ankle bracket (not shown) adapted to attach to the patient's ankle, as illustrated in The Zimmer Institute Surgical Technique, “MIS™ Quad-Sparing™ Surgical Technique for Total Knee Arthroplasty NEXGEN® COMPLETE KNEE SOLUTION”, The Zimmer Institute, 2004 incorporated by reference above and in U.S. Patent Publication No. 2004/0102785, filed on Nov. 27, 2002 in the names of Hodorek et al., entitled METHOD AND APPARATUS FOR ACHIEVING CORRECT LIMB ALIGNMENT IN UNICONDYLAR KNEE ARTHROPLASTY and hereby incorporated by reference. The ankle bracket is attached to the patient's ankle and alignment bar 72 is positioned proximal anterior side T_{A} of tibia T and aligned such that alignment axis A_{A} is aligned with mechanical axis A_{T} of tibia T. Proximal end 72a of alignment bar 72 is then slid within slot 76 until first end 74a of alignment guide 74 contacts tibial tubercle T_{T} and alignment axis A_{A} is parallel to mechanical axis A_{T} of tibia T, at which point locking member 78 is tightened to lock proximal end 72a in position in slot 76. With first end 74a of alignment guide 74 positioned against tibia tubercle T_{T}, alignment guide 74 is secured to tibia by inserting fasteners (not shown) through holes 80 and into tibia T.

Next, cut guide assembly 10 is coupled to tibial boom 14 by inserting extension bar 64 through second opening 34 of guide riser 16. When cut guide assembly 10 is coupled to cross member 16, cut guide slot 54 and cut guide surface 56 lie on a plane that is parallel to slope S of extension bar 64. Accordingly, when alignment bar 72 is aligned parallel with mechanical axis A_{T}, slot 54 and cut guide surface 56 extend at an angle relative to mechanical axis A_{T} that is reflective of the desired posterior tibial slope. Cut guide body 18 and associated cut guide slot 54, is then positioned against anterior side T_{A} of tibia T by making one or more adjustments. More particularly, the position of cut guide slot 54 relative to tibia T may be adjusted medial-laterally by sliding guide riser 16 along extension bar 64. Once cut guide slot 54 is in the proper medial-lateral position, cut guide assembly 10 is locked in position by rotating knob 42 of locking member 38. Rotation of knob 42 causes shaft 40 to move further into hole 36 (FIG. 3) and protrude into second opening 34 to bear against extension bar 64.

The position of cut guide slot 54 relative to tibia T may be adjusted in the proximal distal direction by sliding body 63 on alignment bar 72 along alignment member axis A_{A}. Once cut guide slot 54 is in the proper proximal-distal position, body 63 is locked in position on alignment bar 72 by tightening the locking bolt (not shown) in hole 66. Finally, guide slot 54 may also be rotated about post axis A_{P} to facilitate positioning and advancement through soft tissue and under the patella (not shown). Once properly positioned against tibia T, cut guide body 18 may be secured to tibia T by inserting fasteners (not shown) through holes 62 and into tibia T.

Although tibial cut guide assembly 10 is adapted to couple with cross member 14, assembly 10 could be configured to couple to other cross members or aligning devices. For instance, second opening 34 need not be triangular in cross section, but could have alternative shapes, such as semi-circular, to engage extension bars having other shapes such as that shown in U.S. Patent Publication 2004/0153066 to Coon et al.

It should be noted that, although channel 32 and shoulder 30 are disposed in opening 26 of guide user 16 and boss 60 is disposed on post 58 of guide body, the cut guide assembly could be configured such that these features are reversely positioned. In other words, channel 32 and shoulder 30 may be disposed on post 58, while boss is disposed on wall 28 of opening 26. Furthermore, channel 32 is disposed proximal anterior side 20c of guide riser 16 and boss 60 is disposed on posterior side of post 58 such that post 58 cannot move vertically within opening 26 when bone engaging surface 46 of guide body 18 is facing tibia T (and facing in the same direction as posterior side 20d). This arrangement prevents body 18 from disengaging from riser 16 when body 18 is being positioned against tibia T. It should be understood that channel 32 and boss 60 may be alternatively disposed, for example, proximal posterior side 20d and on anterior side of post 58, respectively. In addition, shoulder 30 of cut guide assembly 10 need not have the shape and configuration illustrated in the embodiment discussed above. For instance, shoulder may be in the form of a bump or rib extending about wall 28.

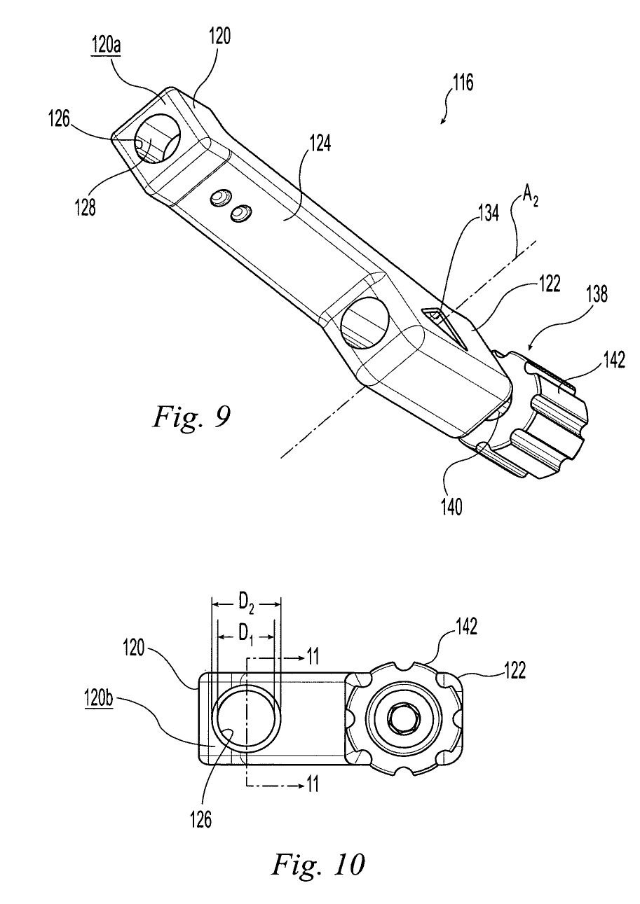

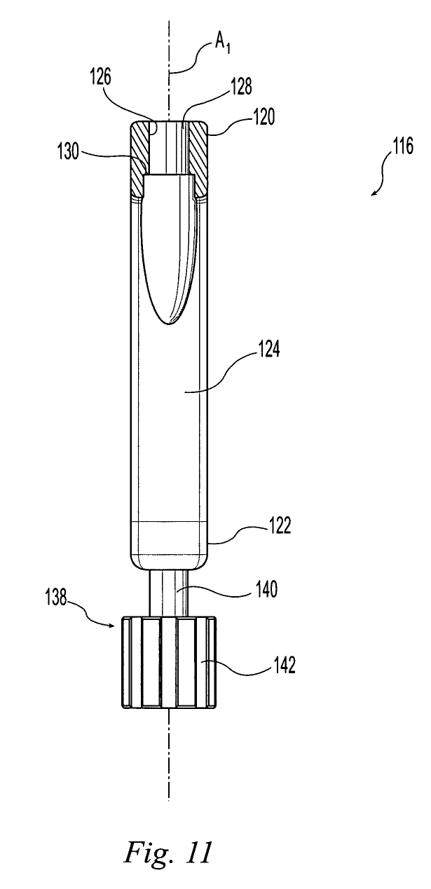

Furthermore, vertical inhibiting member 60 need not be in the form of a cylindrical boss as illustrated in the embodiment described above. For example, turning to FIGS. 9-12, a cut guide assembly according to another embodiment of the present invention is illustrated. Referring to FIGS. 9-11, guide riser 116 includes first end 120, opposite second end 122 and angled portion 124 extending between first and second ends 120, 122. First end 120 has a block-like shape and includes upper surface 120a and lower surface 120b. Guide riser 116 includes first, vertical opening 126 extending through first end 120 from upper surface 120a to lower surface 120b. First opening 126 defines first axis A₁ and is defined by substantially cylindrical wall 128, which extends about first axis A₁. Referring particularly to FIG. 10, first opening 126 has first diameter D₁ and second diameter D₂. Second diameter D₂ is larger than first diameter D₁ such that shoulder or ledge 130 is formed in and extends about wall 128.

Turning now to FIG. 9, guide riser 116 includes second, horizontal opening 134 extending through second end 122 along second axis A₂. Second axis A₂ is substantially perpendicular to first axis A₁. Second opening 134 is triangular in cross-section and is configured to slidingly receive a part of tibial boom 14 (FIGS. 13 and 14). As illustrated in FIGS. 9-11, guide riser 116 also includes threaded hole (not shown), which intersects second opening 134 and receives threaded shaft 140 of locking member 138. Knob 142 is coupled to one end of shaft 140.

Referring now to FIG. 12, cut guide body 118 includes first bone engaging surface 146 and opposing second surface 148. Bone engaging surface 146 is contoured to be positioned against the surface of tibia T (FIGS. 13 and 14). Cut guide body 118 also includes proximal side 150 and opposing distal side 152, both extending between first and second surfaces 146, 148. Cut guide slot 154 extends through guide body 118 from first surface 146 to second surface 148 and provides cut guide surface 156. Slot 154 is configured to receive a cutting instrument, such as a saw, and cut guide surface 156 is adapted to guide the cutting instrument in resecting the proximal end of tibia T (FIGS. 13 and 14). Mounting post 158 extends vertically from distal side 152. Mounting post 158 is substantially cylindrical in shape and defines post axis A_{P}. Mounting post 158 is configured to be rotatably received in first opening 126 of guide riser 116. Cut guide body 118 also includes vertical inhibiting member or ball detent 160, which is spring-biased outwardly from a recess in mounting post 158 at a position proximal to and toward first surface 146. Fastener receiving holes 162 extend through cut guide body 118 from first surface 146 to second surface 148. Cut guide body 118 is rotatably coupled to riser 116 by inserting and forcing mounting post 158 into first opening 126. As mounting post 158 is forced into first opening 126, ball detent 160 is depressed into its recess allowing post 158 to enter opening 126. When ball detent 160 passes shoulder 130 and reaches second diameter D₂, ball detent 160 is spring biased outward. As body 118 is rotated, ball detent travels about wall 128 and engages shoulder 130 to prevent body 118 from inadvertently detaching from riser 116.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A tibial cut guide assembly for resecting a proximal end of a tibia, the tibia including the proximal end, an opposing distal end and a tibial axis extending from the proximal end to the distal end, the cut guide assembly comprising:
a guide riser having a first end and an opposite second end, said first end having a first opening extending therethrough and defining a first axis, said first opening being defined by a wall and including a shoulder extending about said wall, said first opening having a channel defined in said wall and extending parallel to said first axis and through said shoulder; and
a cut guide body having a first bone engaging surface, an opposing second surface and opposing proximal and distal sides extending between said first and second surfaces, said cut guide having at least one cut guide surface extending between said first and second surfaces, said cut guide having a mounting post extending vertically from said distal side and defining a post axis, said mounting post configured to be rotatably received within said first opening of said riser, said cut guide including a boss extending from said mounting post at an angle to said post axis, said boss slidable within said channel to enable said mounting post to be inserted into said first opening, wherein when said mounting post is disposed in said first opening said mounting post is rotatable about said post axis and said boss engages said shoulder to prevent vertical movement of said mounting post in said first opening.

2. The tibial cut guide assembly of claim 1 wherein said second end of said guide riser includes a second opening extending therethrough and defining a second axis, said first axis being substantially perpendicular to said second axis, and wherein said cut guide assembly further includes:
a tibial alignment member defining an alignment axis and adapted to be mounted to the tibia with said alignment axis being parallel to the tibial axis; and
a elongate cross member slidingly mounted to said alignment member and slidable relative to said alignment member along said alignment axis, said cross member defining a cross member axis being substantially perpendicular to said alignment axis, said cross member slidingly received within said second opening of said riser.

3. The tibial cut guide assembly of claim 1 wherein said first opening includes a first diameter and a second diameter, said second diameter being greater than said first to thereby form said shoulder.

4. The tibial cut guide assembly of claim 1 wherein said first end of said guide riser has an anterior side and a posterior side, said channel being disposed proximal said anterior side.

5. The tibial cut guide assembly of claim 4 wherein said boss extends from said mounting post at a position proximal to and toward said first bone engaging surface of said cut guide body.

6. The tibial cut guide assembly of claim 1 wherein said first end of said guide riser has an anterior side and a posterior side, said channel being disposed proximal said posterior side.

7. The tibial cut guide assembly of claim 4 wherein said boss extends from said mounting post at a position proximal to said second surface of said cut guide body.

8. The tibial cut guide assembly of claim 2 wherein said guide riser further includes a locking member, said locking member having a first position wherein said locking member engages with said cross member to lock said riser in position on said cross member, and a second position wherein said locking member is free of said cross member and said cross member is slidable within said second opening of said riser.

9. The tibial cut guide assembly of claim 2 wherein said second opening is triangular in cross section and wherein said cross member includes at least one extension bar, said at least one extension bar having a triangular cross section including a distal flat portion, said distal flat portion defining a slope, said slope extending at a non-perpendicular angle relative to said cross member axis.

10. A tibial cut guide assembly for resecting a proximal end of a tibia, the tibia including the proximal end, an opposing distal end and a tibial axis extending from the proximal end to the distal end, the cut guide assembly comprising:
a tibial alignment member defining an alignment axis and adapted to be mounted to the tibia with said alignment axis being parallel to the tibial axis;
a elongate cross member slidingly mounted to said alignment member and slidable relative to said alignment member along said alignment axis, said cross member defining a cross member axis being substantially perpendicular to said alignment axis;
a guide riser having a first end and a second end, said first end defining a first opening extending therethrough along a first axis, said second end defining a second opening extending therethrough along a second axis, said second axis being substantially perpendicular to said first axis, said cross member being slidingly received within said second opening, said first opening defined by a wall extending about a diameter, said wall having a shoulder extending about said diameter, said first opening having a channel defined in said wall, said channel extending parallel to said first axis and through said shoulder;
a cut guide body having a first bone engaging surface, an opposing second surface and opposing proximal and distal sides extending between said first and second surfaces, said cut guide having at least one cut guide surface extending between said first and second surfaces, said cut guide having a mounting post extending vertically from said distal side and defining a post axis, said mounting post configured to be rotatably received within said first opening of said riser, said cut guide including a boss extending from said mounting post at an angle to said post axis, said boss slidable within said channel to enable said mounting post to be inserted into said first opening, wherein when said mounting post is disposed in said first opening said mounting post is rotatable about said first axis and said boss engages said shoulder to prevent vertical movement of said mounting post in said first opening.

11. The tibial cut guide assembly of claim 10 wherein said first opening includes a first diameter and a second diameter, said second diameter being greater than said first to thereby form said shoulder.

12. The tibial cut guide assembly of claim 10 wherein said first end of said guide riser has an anterior side and a posterior side, said channel being disposed proximal said anterior side, said boss extending from said mounting post at a position proximal to and toward said first bone engaging surface of said cut guide body.

13. The tibial cut guide assembly of claim 10 wherein said first end of said guide riser has an anterior side and a posterior side, said channel being disposed proximal said posterior side, said boss extending from said mounting post at a position proximal to said second surface of said cut guide body.

14. The tibial cut guide assembly of claim 10 wherein said guide riser further includes a locking member, said locking member having a first position wherein said locking member engages with said cross member to lock said riser in position on said cross member, and a second position wherein said locking member is free of said cross member and said cross member is slidable within said second opening of said riser.

15. The tibial cut guide assembly of claim 10 wherein said second opening is triangular in cross section and wherein said cross member includes at least one extension bar, said at least one extension bar having a triangular cross section including a distal flat portion, said distal flat portion defining a slope, said slope extending at a non-perpendicular angle relative to said alignment axis.

16. A tibial cut guide assembly for resecting a proximal end of a tibia, the tibia including the proximal end, an opposing distal end and a tibial axis extending from the proximal end to the distal end, the cut guide assembly comprising:
a guide riser having a first end and an opposite second end, said first end having a first opening extending therethrough and defining a first axis, first opening defined by a wall and including a first diameter and a second diameter, said second diameter being greater than said first to thereby form a shoulder extending about said wall; and
a cut guide body having a first bone engaging surface, an opposing second surface and opposing proximal and distal sides extending between said first and second surfaces, said cut guide having at least one cut guide surface extending between said first and second surfaces, said cut guide having a mounting post extending vertically from said distal side and defining a post axis, said mounting post being rotatably received within said first opening of said riser such that said cut guide body is rotatable relative to said riser about said post axis, said cut guide body including a vertical inhibiting member extending from said mounting post at an angle to said post axis, said vertical inhibiting member engaging said shoulder to prevent vertical movement of said mounting post in said first opening.

17. The tibial cut guide assembly of claim 16 wherein said vertical inhibiting member includes a boss extending perpendicularly from said mounting post, and wherein said first opening includes a channel defined in said wall and extending parallel to said first axis and through said shoulder, said boss slidable within said channel to enable said mounting post to be inserted into said first opening.

18. The tibial cut guide assembly of claim 17 wherein said first end of said guide riser has an anterior side and a posterior side, said channel being disposed proximal said anterior side, said boss extending from said mounting post at a position proximal to and toward said first bone engaging surface of said cut guide body.

19. The tibial cut guide assembly of claim 16 wherein said vertical inhibiting member includes a ball detent.

20. The tibial cut guide assembly of claim 16 wherein said second end of said guide riser includes a second opening extending therethrough at an angle to said riser, and wherein said cut guide assembly further includes:
a tibial alignment member defining an alignment axis and adapted to be mounted to the tibia with said alignment axis being parallel to the tibial axis; and
a elongate cross member slidingly mounted to said alignment member and slidable relative to said alignment member along said alignment axis, said cross member defining a cross member axis being substantially perpendicular to said alignment axis, said cross member slidingly received within said second opening of said riser.

21. A tibial cut guide assembly for resecting a proximal end of a tibia, the tibia including the proximal end, an opposing distal end and a tibial axis extending from the proximal end to the distal end, the cut guide assembly comprising:
a guide riser having a first end and an opposite second end, said first end having a first opening extending therethrough and being defined by a cylindrical wall; and
a cut guide body having a first bone engaging surface, an opposing second surface and opposing proximal and distal sides extending between said first and second surfaces, said cut guide having at least one cut guide surface extending between said first and second surfaces, said cut guide having a cylindrical mounting post extending vertically from said distal side and defining a post axis, said mounting post configured to be rotatably received within said first opening of said riser such that said cut guide body is rotatable relative to said riser about said post axis,
wherein one of said wall and said mounting post includes both a shoulder extending thereabout and a channel defined therein and extending through said shoulder and parallel to said post axis, and wherein the other of said wall and said mounting post includes a boss extending therefrom at an angle to said post axis, wherein said boss is slidable within said channel to enable said mounting post to be inserted into said first opening, wherein when said mounting post is disposed in said first opening said mounting post is rotatable about said first axis and said boss engages said shoulder to prevent vertical movement of said mounting post in said first opening.
